(19) United States
(12) Patent Application Publication
(10) Pub. No.: US 2017/0235389 A1
(43) Pub. Date: Aug. 17, 2017

(54) Touch Panel and Display Device

(71) Applicants: BOE Technology Group Co., Ltd., Beijing (CN); Hefei BOE Optoelectronics Technology Co., Ltd., Anhui (CN)

(72) Inventors: Bo Liu, Beijing (CN); Xianjie Shao, Beijing (CN); Honggang Gu, Beijing (CN); Xiujuan Wang, Beijing (CN)

(21) Appl. No.: 15/234,096

(22) Filed: Aug. 11, 2016

(30) Foreign Application Priority Data
Feb. 14, 2016 (CN) 201610084612.2

(51) Int. Cl. G06F 3/044

(52) U.S. Cl. CPC G06F 3/044

(57) ABSTRACT

A touch panel and a display device are disclosed. The touch panel includes a base substrate and a touch layer located on the substrate, the touch layer includes a plurality of touch unit sets, each of which includes two touch units, and each of the touch units has a first side, a second side and a third side that are connected head-to-tail; the length ratio of the first side to the second side is from 1:3 to 1:4; two touch units of each touch unit set have their third sides face each other.

This application claims priority to and the benefit of Chinese Patent Application No. 201610084612.2 filed on Feb. 14, 2016, which application is incorporated herein in its entirety.

### TECHNICAL FIELD

The embodiments of the present disclosure relates to a touch panel and a display device.

### BACKGROUND

Touch screens have become the primary man-machine-interaction means for personal mobile communication devices and integrated intelligence terminals, such as tablet computers, smart phones, super notebook computer and the like, due to the advantages such as easy and direct operation, flexibility, etc. Touch screens can be classified into four main types according to different touch realization principles, i.e., resistive type touch screen, capacitive type touch screen, infrared type touch screen, and surface acoustic wave (SAW) type touch screen. Capacitive touch screens is advantageous in that it enables multiple-point touch, faster response, long performance life, higher transmittance and the like, thus can provide superior user experience. Also, as the production technology is gradually maturing, the yield also remarkably improves, and the price for capacitive touch screens is rapidly reduced, thus capacitive touch screens have become the major selection for touch interaction in small and medium sized intelligence terminals.

### SUMMARY

An embodiment of the present disclosure provides a touch panel, which includes a base substrate and a touch layer located on the substrate, the touch layer includes a plurality of touch unit sets, each of which includes two touch units, and each of the touch units has a first side, a second side and a third side that are connected head-to-tail; the length ratio of the first side to the second side is from 1:3 to 1:4; two touch units of each touch unit set have their third sides face each other.

Another embodiment of the present disclosure provides a display device comprising the above touch panel.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a structural schematic view of a touch panel;

FIG. 2 is a schematic view illustrating the self-capacitance variation of the touch panel of FIG. 1 when touch occurs to the touch panel;

FIG. 3 is a schematic view of a touch layer according to an example of the embodiment 1 of the present disclosure;

FIG. 4 is a schematic view of a touch layer according to an example of the embodiment 1 of the present disclosure;

FIG. 5 is a schematic view of a touch layer according to another example of the embodiment 1 of the present disclosure; and

FIG. 6 is a schematic view of a touch layer according to another example of the embodiment 1 of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first”, “second”, etc., which are used in the description and the claims of the present application for disclosure, are not intended to indicate any sequence, amount or importance, but distinguish various components. Also, the terms such as “a”, “an”, etc., are not intended to limit the amount, but indicate the existence of at least one. The terms “comprise”, “comprising”, “include”, “including”, etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On”, “under”, “right”, “left” and the like are only used to indicate relative position relationship, and when the position of the object which is described is changed, the relative position relationship may be changed accordingly.

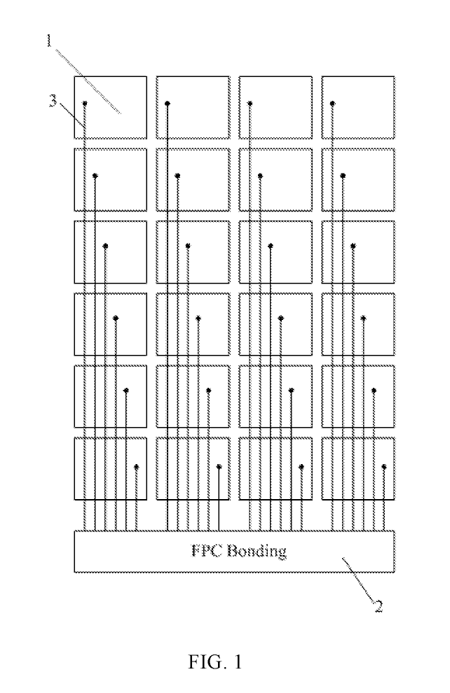

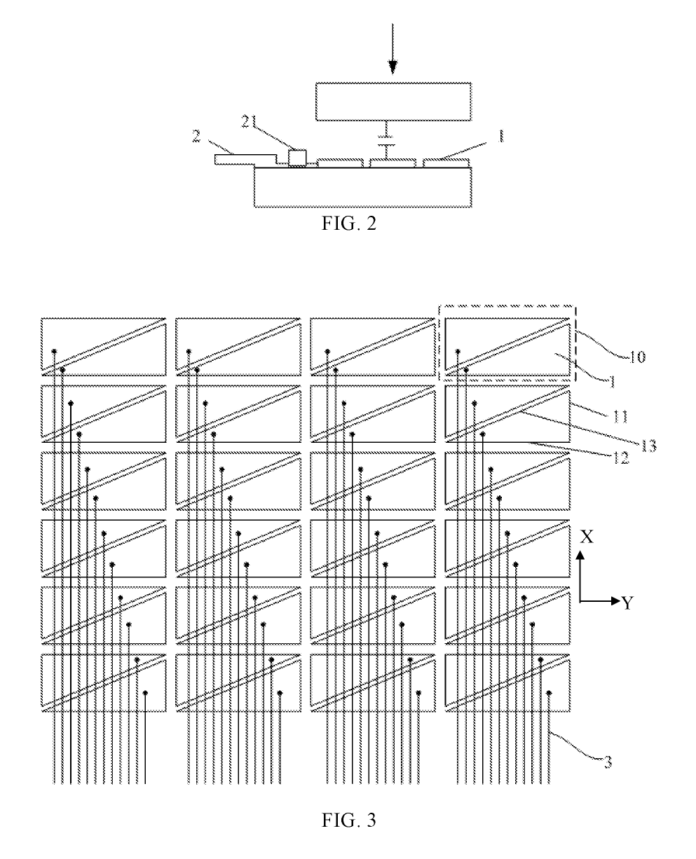

FIG. 1 illustrates a schematic top view of a self-capacitive in-cell touch pattern design. In FIG. 1, each rectangular pattern of a size of 5*5 mm² is one touch unit 1 which acts simultaneously as a TX (transmitting drive signal) unit and a RX (receiving sensing signal) unit. Each touch unit 1 is connected with a pin of a driving chip 21 (IC) arranged within the flexible printing circuit (FPC) bonding area of a flexible circuit board 2 through a signal wire 3. When the touch screen operates, the touch of a human finger or pen may cause variation of the self-capacitance of corresponding rectangular touch unit(s) 1, the drive chip 21 captures such a signal relating to the self-capacitance variation and then determines the specific position of the finger according to the capacitance variation of the touch units 1, as illustrated in FIG. 2.

The inventors have found such a problem that, in the configuration illustrated in FIG. 1, each of the rectangular touch units 1 corresponds to one signal channel, thus the smaller the rectangular touch units 1 are, the bigger the amount of the touch units 1 that occur to capacitance variation in one touch operation is, thus the higher the touch sensitivity is. However, if the amount of the touch units 1 is too much, the space required for the wiring and routing in the Fan-out area of the touch panel is enormously increased, thereby causing a wider frame, and furthermore, as the amount of the touch units 1 increases, the power consumption will also be raised correspondingly, and moreover it is more difficult to perform FPC bonding.

### First Embodiment

As illustrated in FIGS. 3-6, this embodiment provides a self-capacitive in-cell touch panel, which comprises an array substrate and a cell-assembling substrate arranged facing each other (the cell-assembling substrate may be a color filter substrate). The array substrate comprises a base substrate and a touch layer located on the base substrate, the touch layer comprises a plurality of touch unit sets 10, each touch unit set 10 comprises two touch units 1, each of the touch units 1 has a first side 11, a second side 12 and a third side 13 connected head-to-tail; the length ratio of the first side 11 to the second side 12 is from 1:3 to 1:4; the two touch units 1 of each touch unit set 10 are arranged to allow their third sides 13 to face each other, for example, these two third sides 13 are parallel with each other. A gap is provided between adjacent two third sides to separate two touch units 1, and the size of the gap can be determined according to the size of the touch unit 1.

In this embodiment, since each touch unit 1 has three sides connected head-to-tail, when the three sides are each straight lines, the touch unit 1 is of a triangle shape, and when one of the sides is a curve, the touch unit 1 is in a pattern like a triangle, regardless of which kind of case, thus, when a human's finger touches the touch panel, it is certainly that the self-capacitance of at least the two touch units 1 will vary. However, as to the rectangular touch unit as illustrated in FIG. 1 for example, when touching occurs, the number of the touch units 1 that occur to self-capacitance variation is one in the minimum situation, and therefore, the touch layer provided in this embodiment has a significantly improved sensitivity compared with the touch layer formed of rectangular touch units.

Furthermore, the first side 11 and the second side 12 of the touch unit 1 in this embodiment has a length ratio of 1:3 to 1:4, and therefore in the case where the first side 11 in this embodiment has a side length identical to the rectangular touch unit 1 as illustrated in FIG. 1 for example, the number of the touch units 1 of this embodiment within an unit area of the display panel can be decreased by about ⅓, thus the number of the touch signal wires 3 (each of the touch signal wires 3 is connected with one touch unit 1) decreases accordingly, it is possible to improve the aperture ratio of pixels, reduce the space required for wiring and routing in the Fan-out area so that the frame of the touch panel can become narrower, and it is also possible to reduce power consumption and the difficulty for FPC bonding. For example, the touch signal wires are connected to a touch control chip (IC). The touch control chip is configured to apply touch driving signals and receive touch sensing signals.

The first side 11 and the second side 12 of the touch unit in this embodiment are provided at a right angle to each other, that is to say, the configuration of the touch unit 1 may be a right triangle, or a shape like a right triangle. It can be understood that, one of the first side 11 and the second side 12 is parallel with the row direction (the X-direction in the drawing), and the other is parallel with the column direction (the Y-direction in the drawing), thus the touch unit 1 of such a configuration facilitates preparation and the manufacturing process becomes simpler. Of course, the first side 11 and the second side 12 may not form a right angle, for example an obtuse angle, in this case each the touch unit set 10 is entirely shaped as a parallelogram. The angle between the first side 11 and the second side 12 can be set according to the shape of the display panel.

In this embodiment, in an example, the touch unit 1 can be multiplexed as the common electrode on the array substrate in a time-division manner, that is, the touch unit 1 is applied with a common voltage signal in the display phase, while the touch unit 1 is applied with a touch scanning signal in the touch phase. Thus, for example, the same structure can be used as touch units as well as common electrodes (cooperating pixel electrodes in display operation). Thus, the complexity in structure is not obviously increased, the manufacturing cost is saved, and the thickness of the touch panel will not be increased. The material for the touch unit 1 is transparent conductive material, such as indium tin oxide (ITO) or the like.

As illustrated in FIG. 3, the first sides 11 of the two touch units 1 in each touch unit set 10 are provided parallel with each other in a column direction or in a direction at a certain angle with the column direction; and the second sides 12 of the two touch units 1 in each touch unit set 10 are provided parallel with each other in a row direction or in a direction of a certain angle with the row direction.

To facilitate understanding, in the present disclosure, the direction along which the first side 11 is located is defined as the first direction, the direction along which the second side 12 is located is defined as the second direction; when the angle between the first side 11 and the second side 12 at the connection point is a right angle, the first direction is the row direction, and the second direction is the column direction. Hereinafter the description will be made as to the touch panel by taking the angle between the first side 11 and the second side 12 being a right angle as an example.

In this embodiment, the length ratio of the first side 11 to the second side 12 is from 1:3 to 1:4, that is, the length of each touch unit 1 in the row direction is greater than that in the column direction. The third side 13 connects with the first side 11 and the second side 12, each touch unit set 10 having two touch units 1 are in a shape of rectangular as a whole, so that the touch unit sets 10 are distributed evenly in the row direction and the column direction, thus contributing to improve the display homogeneity of the touch panel.

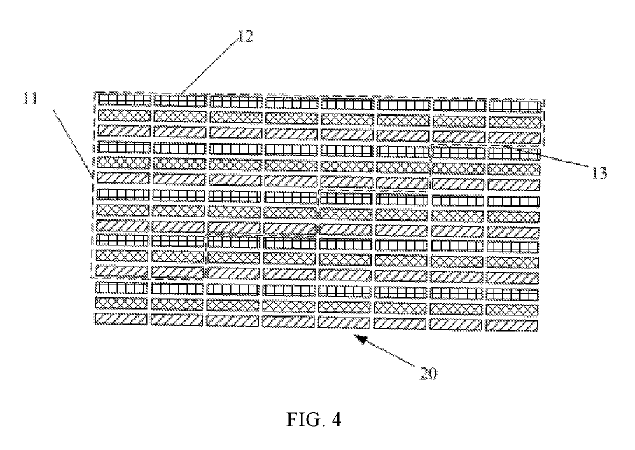

The touch panel further comprises a pixel array 20 arranged opposite to the touch layer; the pixel array 20 comprises a plurality of pixel units arranged in a matrix. Each pixel unit may comprise, for example, three different colors of sub-pixels, that is, the red, green, blue sub-pixels. Each sub-pixel may further comprise a pixel electrode, a thin film transistor, and so on. As illustrated in FIG. 4, the third side 13 of each of the touch units 1 is provided along the edge of pixel units, and is in form of step line, for example, stair step line. That is, the third side 13 is provided between adjacent pixel units and thus will not influence the display of the pixel units. Furthermore, in order to facilitate fabrication and also to even better improve the sensitivity of the touch panel, the stepped third side 13 comprises a plurality of stepped portions, each of which has a width ratio of 2:1 in the row direction and the column direction, that is, as illustrated in FIG. 4. Naturally, the third side 13 of the touch unit 1 is not restricted to the configuration in this embodiment but can be particularly provided according to specific circumstances.

As an example in this embodiment, the first sides 11 of the two touch units 1 of each touch unit set 10 are provided parallel with each other in a row direction or in a direction of a certain angle with the row direction; and the second sides 12 of the two touch units 1 of each touch unit set 10 are provided parallel with each other in a column direction or in a direction at a certain angle with the column direction.

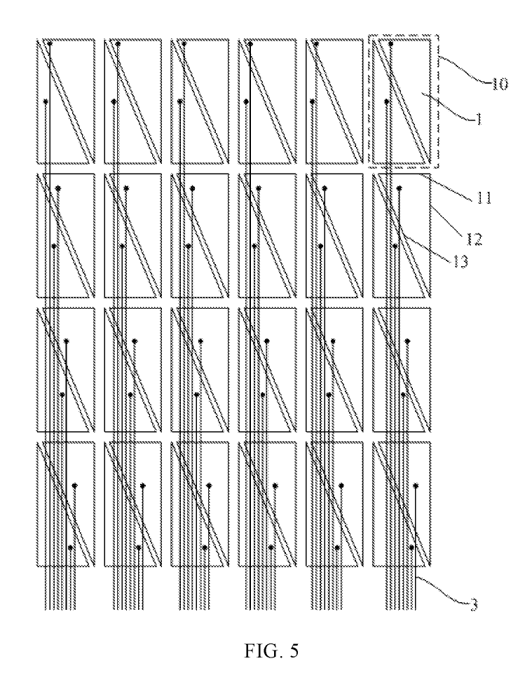

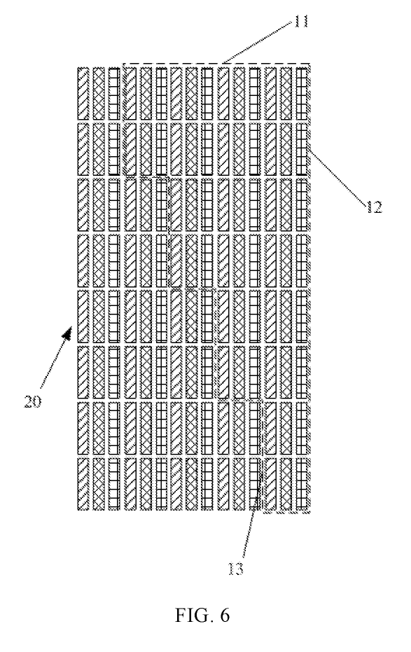

As can be seen from FIGS. 5 and 6, if each touch unit set 10 in the above embodiment is laid horizontally, then the touch unit set 10 of such an embodiment corresponds to the case in which the touch unit set 10 of the above embodiment as illustrated in FIG. 4 is rotated by 90° and placed vertically, while other configuration is identical to that of the above embodiment, and its detailed description is omitted here.

Of course, those skilled in the art can understand that, in the embodiment, the touch layer can be provided on the cell-assembling substrate as well. For example, the touch layer can be provided on the outer side (far away from the array substrate) or the inner side (facing the array substrate). The configuration of the touch layer on the cell-assembling substrate may be the same as those as illustrated in FIG. 3 to FIG. 6.

In summary, the touch panel provided by this embodiment has a higher sensitivity, simpler wiring, narrower frame, and reduced power consumption.

### Second Embodiment

This embodiment provides a display device comprising the touch panel of the first embodiment.

The display device may be a liquid crystal display device, an organic light-emitting display device, or an e-ink display device, for example, implemented as a liquid crystal panel, an electronic paper, a cellphone, a tablet computer, a television, a display, a notebook computer, a digital photo frame, a navigator and any products or parts having display functions. The display device in this embodiment has a higher sensitivity, simpler wiring, narrower frame, and reduced power consumption.

The above are only exemplary embodiments of the present disclosure, rather than limiting the protection reach of the present disclosure, the protection reach of the present disclosure is determined by the attached claims.

The present application claims the priority of the Chinese patent application No. 201610084612.2 filed on Feb. 14, 2016, the entirety of which is incorporated herein by reference as a part of the present application.

What is claimed is:

1. A touch panel comprising a base substrate and a touch layer located on the substrate,
wherein the touch layer comprises a plurality of touch unit sets, each of which comprises two touch units, and each of the touch units has a first side, a second side and a third side that are connected head-to-tail;
a length ratio of the first side to the second side is from 1:3 to 1:4; and two touch units of each touch unit set have their third sides face each other.

2. The touch panel according to claim 1, wherein the two touch units of each touch unit set have their first side provided parallel to each other in a column direction or in a direction at a certain angle with the column direction; and
the two touch units of each touch unit set have their second sides provided parallel to each other in a row direction or in a direction of a certain angle with the row direction.

3. The touch panel according to claim 1, wherein the two touch units of each touch unit set have their first sides provided parallel to each other in a row direction or in a direction of a certain angle with the row direction; and
the two touch units of each touch unit set have their second sides provided parallel to each other in a column direction or in a direction at a certain angle with the column direction.

4. The touch panel according to claim 1, wherein the first side and the second side of each touch unit are provided at a right angle to each other.

5. The touch panel according to claim 1, further comprising a pixel array provided opposite to the touch layer;
wherein the pixel array comprises a plurality of pixel units arranged in matrix.

6. The touch panel according to claim 5, wherein the third side of the touch unit is provided along the edge of the pixel unit and is in a form of step line.

7. The touch panel according to claim 6, wherein the third side in the form of step line comprises a plurality of stepped portions, each of which has a width ratio of 2:1 in a row direction and in a column direction.

8. The touch panel according to claim 1, wherein the touch layer is configured to be multiplexed as a common electrode layer of the touch panel in a time-division manner.

9. The touch panel according to claim 1, wherein a material for the touch unit is indium tin oxide.

10. A display device comprising the touch panel according to claim 1.
